(19) United States
(12) Patent Application Publication
(10) Pub. No.: US 2026/0148170 A1
(43) Pub. Date: May 28, 2026

(54) RISK SCENARIO EVALUATION SYSTEM AND RISK SCENARIO EVALUATION METHOD

(71) Applicant: Hitachi, Ltd., Tokyo (JP)

(72) Inventors: Hiroyuki KOBAYASHI, Tokyo (JP); Tazu NOMOTO, Tokyo (JP); Akihisa TSUJIBE, Tokyo (JP)

(21) Appl. No.: 19/300,714

(22) Filed: Aug. 15, 2025

(30) Foreign Application Priority Data
Nov. 25, 2024 (JP) 2024-204598

(51) Int. Cl. G06Q 10/0635; G06Q 10/08

(52) U.S. Cl. CPC G06Q 10/0635; G06Q 10/08

(57) ABSTRACT

A risk scenario evaluation system includes: a damage record structuring section for generating damage record structured information storing a damage target, a damage scale, and a damage period as a database in an available format from damage record information storing as a text of a natural language on the basis of damage classification master data storing a damage target that is a type of a damage to be noted, a method of defining the damage scale, and a method of defining the damage period; and a damage record abstracting section that generates damage record abstracted information storing the risk type value from the damage record structured information in association with the damage target, the damage scale, and the damage period on the basis of risk response master data storing the risk type value that is an index of a magnitude of an impact on the damage target by risk type.

### CROSS REFERENCE TO RELATED APPLICATIONS

The present invention claims priority under 35 U.S.C. § 119 to Japanese Patent Application Number 2024-204598, filed Nov. 25, 2024, the entire content of which is incorporated herein by reference.

### TECHNICAL FIELD

The present invention relates to a risk scenario evaluation system and a risk scenario evaluation method.

### BACKGROUND ART

In recent years, the risk of supply chain disruption is increasing with, e.g., increasing geopolitical risks. To improve the business continuity of a company, measures against disasters and geopolitical risks are required in peacetime. In particular, it is important to previously predict and evaluate damages that impact supply chains due to assumed risks, scales thereof, and periods thereof.

A background technology of the present technical field is described in Patent Literature 1. A supply chain assist system of Patent Literature 1 includes: supply chain information acquisition means; model setting means for setting a supply chain model to individually respond to a normal time and to an occurrence of a risk event; estimation data derivation means for deriving estimation data that estimates a chronological situation in a supply chain; record data acquisition means for chronologically acquiring record data from the supply chain; risk determination means for determining the presence or absence of an occurrence of record data; and risk system derivation means for deriving a system of the supply chain that minimizes a loss due to a risk upon an occurrence of the risk event and for deriving a risk cost by using a risk response supply chain model to perform simulation upon the occurrence of the risk event.

### CITATION LIST

### Patent Literature

Patent Literature 1: Japanese Unexamined Patent Application Publication No. 2011-227852

### SUMMARY OF INVENTION

### Technical Problem

The supply chain assist system of Patent Literature 1 estimates a chronological situation of a supply chain, determines the presence or absence of an occurrence of a risk by comparing the situation to the record data of the supply chain, and derives a measure that minimizes a loss due to a risk upon an occurrence of the risk and a risk cost.

However, the supply chain assist system of Patent Literature 1 is capable of developing a measure plan against a trouble and a disaster after the occurrence of the trouble and disaster, but incapable of assuming a trouble and a disaster occurring on a supplier in peacetime, and of evaluating a damage, a damage scale, and a damage period due to the trouble and disaster. In addition, the supply chain assist system of Patent Literature 1 is incapable of evaluating the damage, the damage scale, and the damage period due to a trouble and a disaster that have no past damage record.

Thus, an object of the present invention is to evaluate the damage scale and the damage period due to the trouble and the disaster that may occur on a supply chain in peacetime without exception.

### Solution to Problem

A risk scenario evaluation system of the present invention includes: a damage record structuring section for generating damage record structured information storing a damage target, a damage scale, and a damage period as a database in an available format from damage record information storing a cause of a damage, the damage scale, and the damage period in a supply chain as a text of a natural language on the basis of damage classification master data storing a damage target that is a type of a damage to be noted, a method of defining the damage scale, and a method of defining the damage period; and a damage record abstracting section that generates damage record abstracted information storing the risk type value from the damage record structured information in association with the damage target, the damage scale, and the damage period on the basis of risk response master data storing the risk type value that is an index of a magnitude of an impact on the damage target by the risk type related to the cause of the damage.

The other means is explained in Embodiments of the present invention.

### Advantageous Effects of Invention

According to the present invention, the damage scale and the damage period due to a trouble and a disaster that may occur on a supply chain are evaluated in peacetime without exception. More specifically, according to the present invention, a risk to a supplier is assumable, and a buyer using the present invention is capable of estimating, in peacetime, a damage scale and a damage period suffered by the supplier due to a trouble and a disaster. Thus, the buyer is capable of developing measure plans to avoid the risk in advance to meet the damage content, the damage scale, and the damage period that are assumed from the risk to the supplier.

### BRIEF DESCRIPTION OF DRAWINGS

FIG. 1 is a functional block diagram of a risk scenario evaluation system.

FIG. 2 is a hardware configuration diagram of the risk scenario evaluation system.

FIG. 3 is a flowchart of an entire procedure.

FIG. 4 is a flowchart of a detailed procedure at Step S10 of FIG. 3.

FIG. 5 shows one example of damage record information.

FIG. 6 shows one example of damage classification master data.

FIG. 7 shows one example of damage record structured information.

FIG. 8 explains structuring of the damage record information.

FIG. 9 is a flowchart of a detailed procedure at Step S20 of FIG. 3.

FIG. 10 shows one example of risk response master data.

FIG. 11 shows one example of damage record abstracted information.

FIG. 12 is a flowchart of a detailed procedure at Step S30 of FIG. 3.

FIG. 13 shows one example of supply chain information.

FIG. 14 shows one example of risk scenario information.

FIG. 15 explains filtering at Step S320 of FIG. 12.

FIG. 16 explains filtering at Step S330 of FIG. 12.

FIG. 17 shows one example of risk scenario evaluation information.

FIG. 18 is one example of a risk scenario evaluation result screen.

### DESCRIPTION OF EMBODIMENTS

Hereinafter, embodiments (the present embodiments) of the present invention are explained using the drawings.

### Sort of Terms

According to the present embodiment, the terms a “cause,” a “risk type,” and a “risk type value” are similar to each other, but are concepts to be clearly distinguished from each other.

The cause is an event to cause damages, such as a “cold wave,” a “drought,” a “hurricane,” and “flood.” The cause is not limited to natural phenomena, and may include an economical event, a political event, a conflict event, a criminal event, or an event such as an infectious disease. In any case, it is important that the term the “cold wave” etc. that is the cause is described generally intact in open data such as news.

The risk is a cause seen from the perspective of a manager of a risk scenario evaluation system. Thus, for example, the “flood” is a cause as a term described in open data, and is a risk when seen from the perspective of the manager. The term the cause contains the meaning of “an event that has actually occurred.” In contrast, the term the risk contains the meaning of “an event to be proactively noted even when not directly appearing in, e.g., news, in conjunction with events appearing in, e.g., news.”

The risk type is a superordinate concept that summarizes the risks causing the same or similar damages. As described above, the risk is a cause seen from the manager. The risk type is also a superordinate concept of a cause. For example, the “cold wave,” “drought,” “hurricane,” and “flood,” which are causes described in the open data, are risks seen from the manager. These risks belong to “earthquake, flood, drought” of the risk type. The imagination by a person facing the news of a “cold wave” is limited to the actual image of the “cold wave,” and difficult to expand to the “drought,” “hurricane,” and “flood,” which also are normally to be measured. The risk type complements this insufficient part of the imagination. According to the present embodiment, the risk types are assigned with signs A, B, C, and so on.

The risk type value is an index indicating a magnitude of an impact on a damage target (after-mentioned in detail) by the risk type. The risk type value is defined for each combination of the damage target and the risk type.

### Function of Risk Scenario Evaluation System

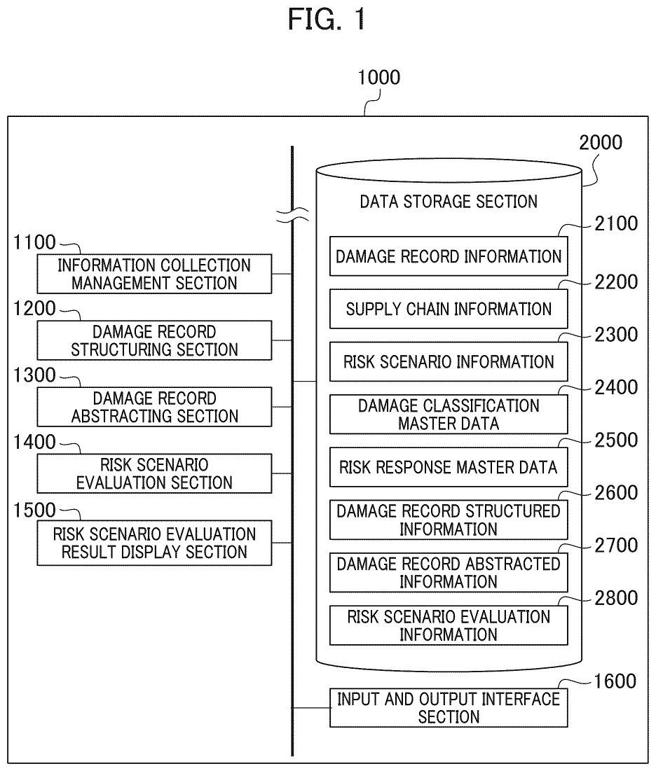

FIG. 1 is a functional block diagram of a risk scenario evaluation system 1000. The risk scenario evaluation system 1000 includes an information collection management section 1100, a damage record structuring section 1200, a damage record abstracting section 1300, a risk scenario evaluation section 1400 and a risk scenario evaluation result display section 1500. These are programs describing procedures of information processing. The risk scenario evaluation system 1000 also includes an input and output interface section 1600 and a data storage section 2000.

The information collection management section 1100 acquires text data (unstructured data) describing, in, e.g., a natural language, a location of a damage on a company in a supply chain, a cause of the damage, the damage scale, the damage period, and the like, from open data such as news and reports of governments and investigation agencies via a communication device or an input screen provided by the input and output interface section 1600 and stores the text data in the data storage section 2000 as damage record information 2100.

The information collection management section 1100 acquires data of user's supply chain constituent companies, position information of the constituent companies, and handled items of the constituent companies from, e.g., a database and an EDI (Electronic Data Interchange) system via a communication device or an input screen provided by the input and output interface section 1600, and stores the data in the data storage section 2000 as supply chain information 2200. The supply chain information 2200 stores suppliers in association with damage locations as conditions (filtering conditions) for limiting a record of damage record abstracted information.

The information collection management section 1100 extracts the main points (country, region, risk, and risk type) from the damage record information 2100, and stores the main points in the data storage section 2000 as risk scenario information 2300. The risk scenario information 2300 stores the risk types as conditions (filtering conditions) for limiting a record of damage record abstracted information 2700.

The information collection management section 1100 acquires data storing a damage target that is a damage type to be noted, a definition method for the damage scale, and the definition method for the damage period, and stores the acquired data in the data storage section 2000 as damage classification master data 2400 via the input screen provided by the input and output interface section 1600.

The information collection management section 1100 acquires risk response master data 2500 storing the risk type value that is an index of a magnitude of an impact on a damage target by the risk type as a superordinate concept of a cause of a damage, and stores the risk response master data 2500 in the data storage section 2000 via the input screen provided by the input and output interface section 1600.

The damage record structuring section 1200 generates damage record structured information 2600 structuring a location of the damage, the damage target, the damage scale, and the damage period as a database in an available format from the damage record information 2100 that is unstructured data on the basis of the damage classification master data 2400, and stores damage record structured information 2600 in the data storage section 2000.

The damage record abstracting section 1300 generates the damage record abstracted information 2700 storing the risk type values from the damage record structured information 2600 in association with a location of the damage, the damage target, the damage scale, and the damage period on the basis of the risk response master data 2500, and stores the damage record abstracted information 2700 in the data storage section 2000. Note that “abstracting” means “generalization away from specific examples” or “extraction of an essence common in each specific example.”

The risk scenario evaluation section 1400 generates risk scenario evaluation information 2800 storing statistics of the damage scales and statistics of the damage periods from the damage record abstracted information 2700 in association with suppliers and damage targets for each supplier and each damage target on the basis of the supply chain information 2200 and the risk scenario information 2300, and stores the risk scenario evaluation information 2800 in the data storage section 2000.

The risk scenario evaluation result display section 1500 displays the risk scenario evaluation information 2800, and notifies the user of the damage scale and the damage period for each supplier and each damage target.

### Hardware Configuration of Risk Scenario Evaluation System

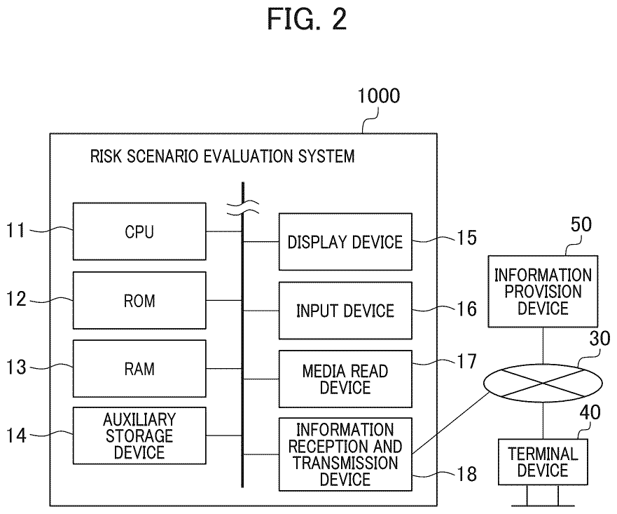

FIG. 2 is a hardware configuration of the risk scenario evaluation system 1000. The risk scenario evaluation system 1000 is connected to a terminal device 40 and an information provision device 50 to each other via a network 30. The risk scenario evaluation system 1000 is achievable as a general computer. Therefore, the risk scenario evaluation system 1000 includes a CPU (Central Processing Unit) 11, a ROM (Read Only memory) 12, a RAM (Random Access Memory) 13, an auxiliary storage device 14, a display device 15, an input device 16, a media read device 17 and an information reception and transmission device 18.

The CPU 11 is a processor to execute various operations. To execute the operations, the CPU 11 loads the above programs from the auxiliary storage device 14 to the ROM 12 to achieve a function of each program.

The risk scenario evaluation system 1000 may install the above programs as applications executable on an OS (Operating System) program, for example, from a portable storage medium to the auxiliary storage device 14 via the media read device 17.

The ROM 12 is a memory storing the programs executed by the CPU 11, the data required to execute the programs, and so on.

The RAM 13 is a memory storing the other programs required to activate the risk scenario evaluation system 1000.

The auxiliary storage device 14 is a device such as an HDD (Hard Disk Drive) or an SSD (Solid State drive). The auxiliary storage device 14 may be achieved as a device different from the risk scenario evaluation system 1000. In this case, the auxiliary storage device 14 may be achieved as, e.g., a file server connected to the network 30. The auxiliary storage device 14 may be provided both inside and outside the risk scenario evaluation system 1000 and share and store, e.g., information. Note that the auxiliary storage device 14 of FIG. 2 corresponds to the data storage section 2000 of FIG. 1.

The display device 15 is a device such as a CRT (Cathode Ray Tube) display, an LCD (Liquid Crystal Display), or an organic Electro-Luminescence) display to execute the function of the risk scenario evaluation result display section 1500 of FIG. 1.

The input device 16 is a device such as a keyboard, a mouse, or a microphone, and executes the function of the input and output interface section 1600 of FIG. 1. When the risk scenario evaluation system 1000 is achieved in a so-called server, the display device 15 and the input device 16 are omitted, the functions of which are served by the terminal device 40. The display device 15 and the input device 16 may be integrated with each other as a touch panel.

The media read device 17 is a device to read information about portable storage media such as CD-ROMs.

The information reception and transmission device 18 is a device to receive and transmit data from and to an external device such as the terminal device 40 via the network 30, and is, e.g., a communication device that communicates with the network 30 such as a wired LAN or a wireless LAN, a dialup router, or an infrared communication device. The information reception and transmission device 18 executes the function of the input and output interface section 1600 of FIG. 1.

The risk scenario evaluation system 1000 of the present embodiment is a server, and uses the network 30, the terminal device 40, and the information provision device 50.

The network 30 may perform communications between the devices, and use any communication type such as an LAN or a WAN.

The terminal device 40 is a computer such as a personal computer or a tablet terminal, has the functions of the display device 15 and the input device 16, receives manipulations from the user, and displays, e.g., processing results in the risk scenario evaluation system 1000. The number of the terminal device 40 may be multiple.

The information provision device 50 is a computer such as a server to provide various pieces of information, and includes a system providing open data, an EDI system, and a system providing information about supply chains. Then, the risk scenario evaluation system 1000 acquires various pieces of information from the information provision device 50 as described below.

### Flowchart of Entire Procedure

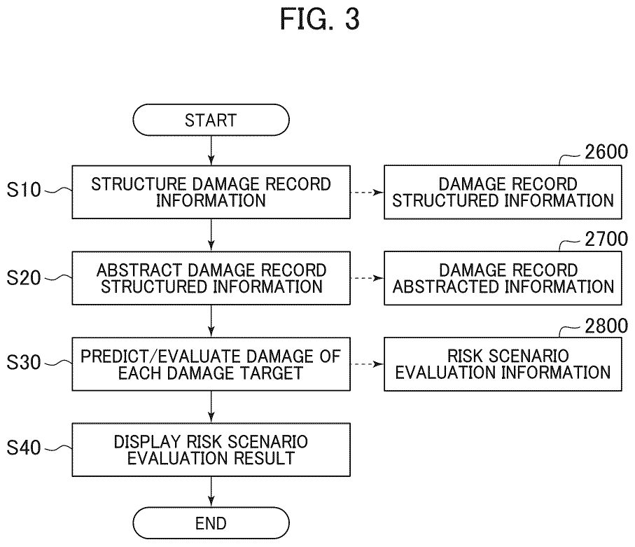

FIG. 3 is a flowchart of an entire procedure.

At Step S10, The damage record structuring section 1200 of the risk scenario evaluation system 1000 structures the damage record information 2100 to generate the damage record structured information 2600.

At Step S20, the damage record abstracting section 1300 of the risk scenario evaluation system 1000 abstracts the damage record structured information 2600 to generate the damage record abstracted information 2700.

At Step S30, the risk scenario evaluation section 1400 of the risk scenario evaluation system 1000 generates the risk scenario evaluation information 2800 from the damage record abstracted information 2700 to estimate and evaluate the damage for each supplier and each damage target.

At Step S40, the risk scenario evaluation result display section 1500 of the risk scenario evaluation system 1000 displays the risk scenario evaluation information 2800 as an evaluation result.

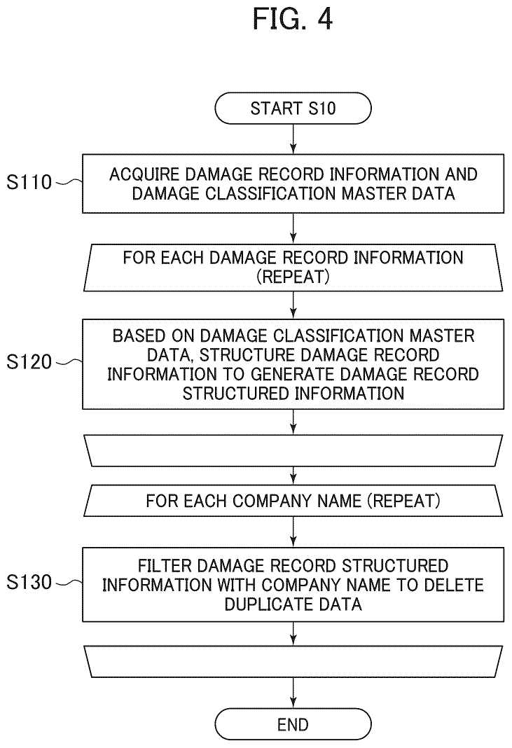

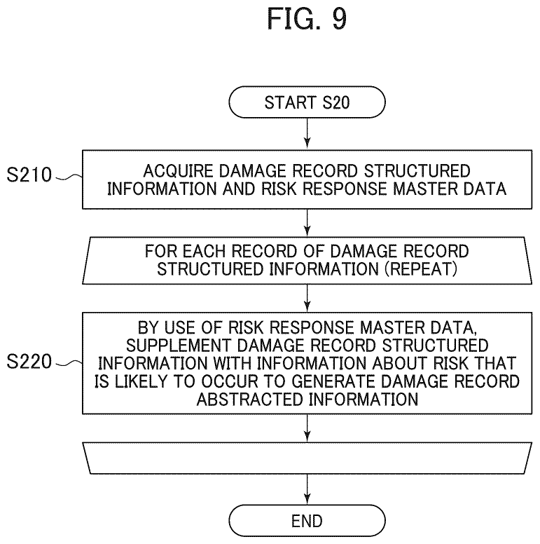

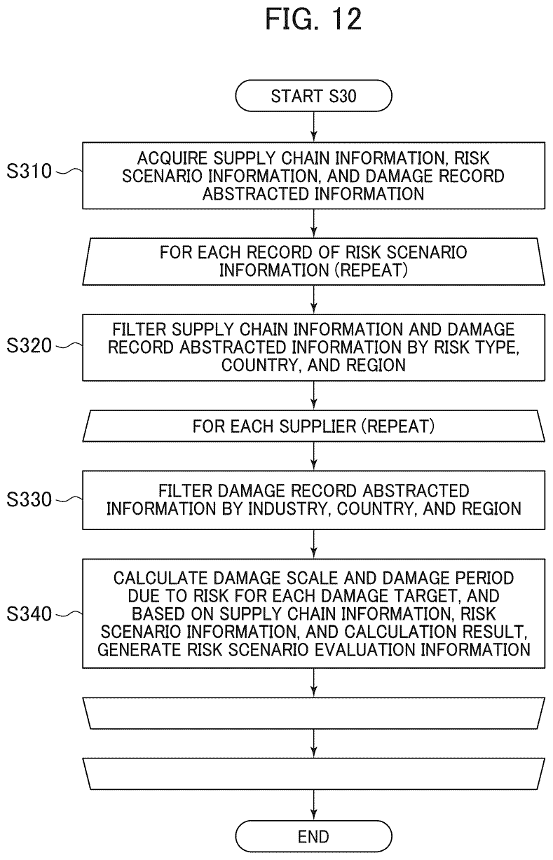

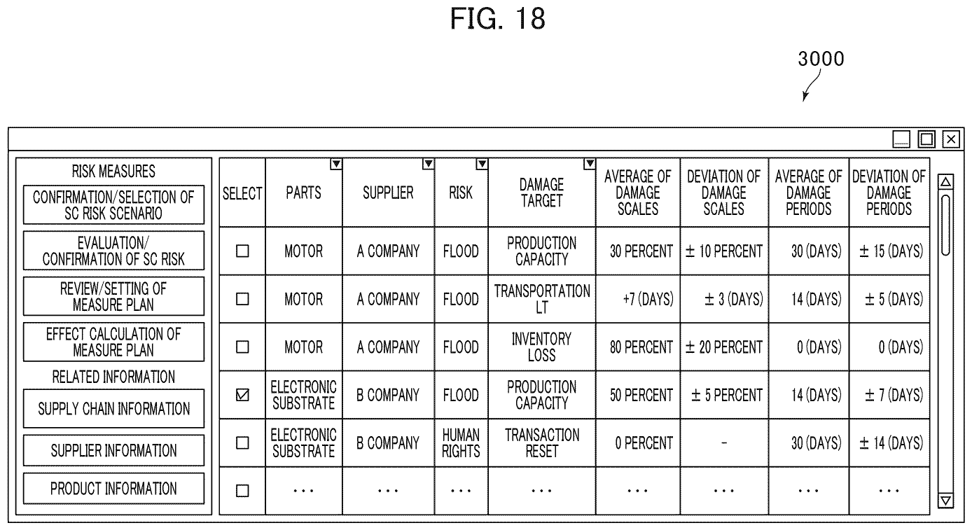

Details at Step S10 are described below as FIG. 4. Details at Step S20 are described below as FIG. 9. Details at Step S30 are described below as FIG. 12. A details screen at Step S40 is described below as FIG. 18.

### Details at Step S10

FIG. 4 is a flowchart of a detailed procedure at Step S10 of FIG. 3.

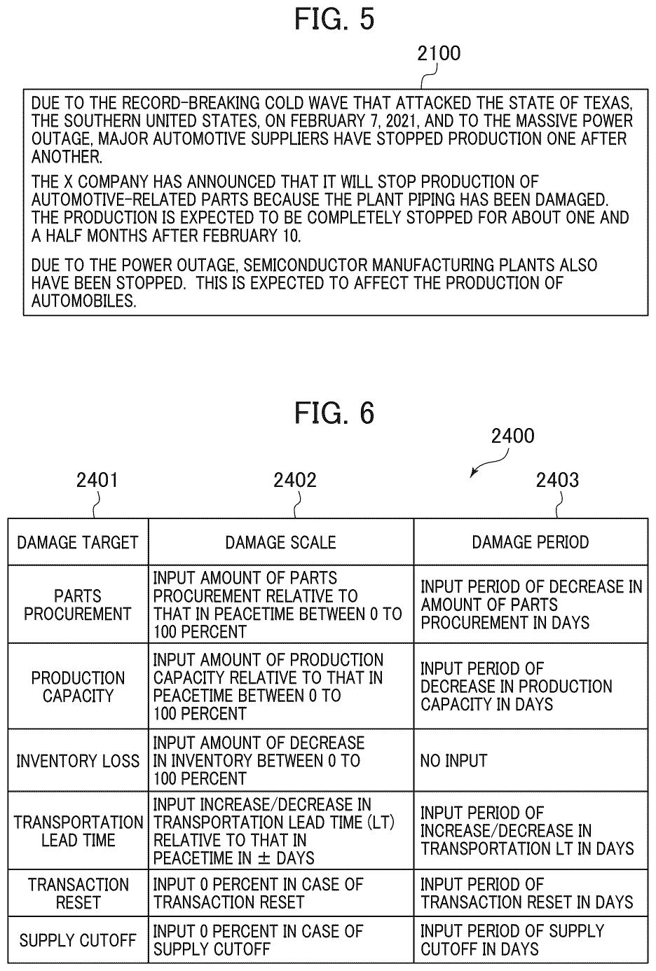

At Step S110, the damage record structuring section 1200 acquires the damage record information 2100 and the damage classification master data 2400 stored in the data storage section 2000. The explanation proceeds to FIGS. 5 and 6 once in the middle of the explanation of FIG. 4.

### Damage Record Information

FIG. 5 shows one example of the damage record information 2100. The damage record information 2100 describes (stores) an industry of a supply chain, a damage on the supply chain, a cause of the damage, the damage scale, and the damage period as a text of a natural language. Specifically, FIG. 5 is a news report about production stoppage of automotive parts of the X company due to the large scale power outage caused by the record-breaking cold wave occurred in North America on Feb. 7, 2021. However, it is unexpectedly difficult for the user to understand the summary of such unstructured data rapidly and correctly.

The information collection management section 1100 acquires these unstructured data from, e.g., the Web or outer databases through processing such as crawling and scraping via the input and output interface section 1600, and stores the unstructured data as the damage record information 2100 in the data storage section 2000.

### Damage Classification Master Data

FIG. 6 shows one example of the damage classification master data 2400. The information collection management section 1100 acquires the damage classification master data 2400 by a manual input or a data upload via, e.g., the input and output interface section 1600. The damage classification master data 2400 stores damage targets (column 2401), the definition methods for damage scales (column 2402), and the definition methods for the damage periods (column 2403) in association with each other.

The damage target is a type (angle or viewpoint) of the damage to be noted for analyzing damages based on a corporate activity. The damage targets herein include “parts procurement,” “production capacity,” “inventory loss,” “transportation lead time,” “transaction reset,” and “supply cutoff.” These damage targets are to be consistently noted by the companies in the manufacturing industry also in peacetime.

A damage scale column 2402 stores the definition methods for the damage scales. For example, “input of an amount of parts procurement between 0 to 100 percent” is associated with the “parts procurement.” In such a way, this indicates that the damage record structuring section 1200 briefly quantifies the details about the damage scale described in the damage record information 2100.

A damage period column 2403 stores the definition methods for the damage periods. For example, “input of a period during which an amount of parts procurement decreases by the number of days” is associated with the “parts procurement.” In such a way, this indicates that the damage record structuring section 1200 briefly quantifies the details about the damage period described in the damage record information 2100. The explanation returns to FIG. 4.

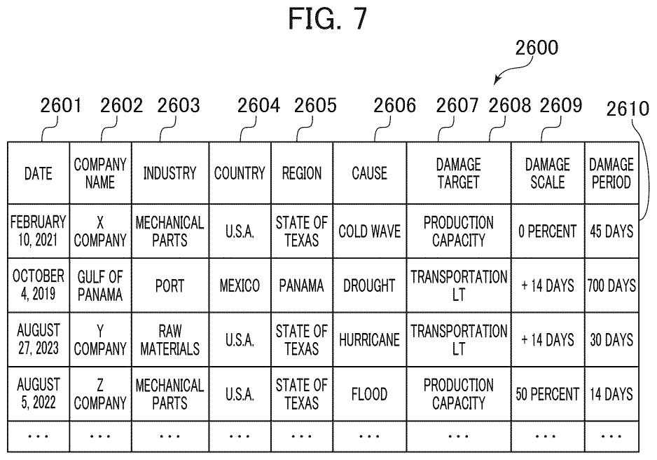

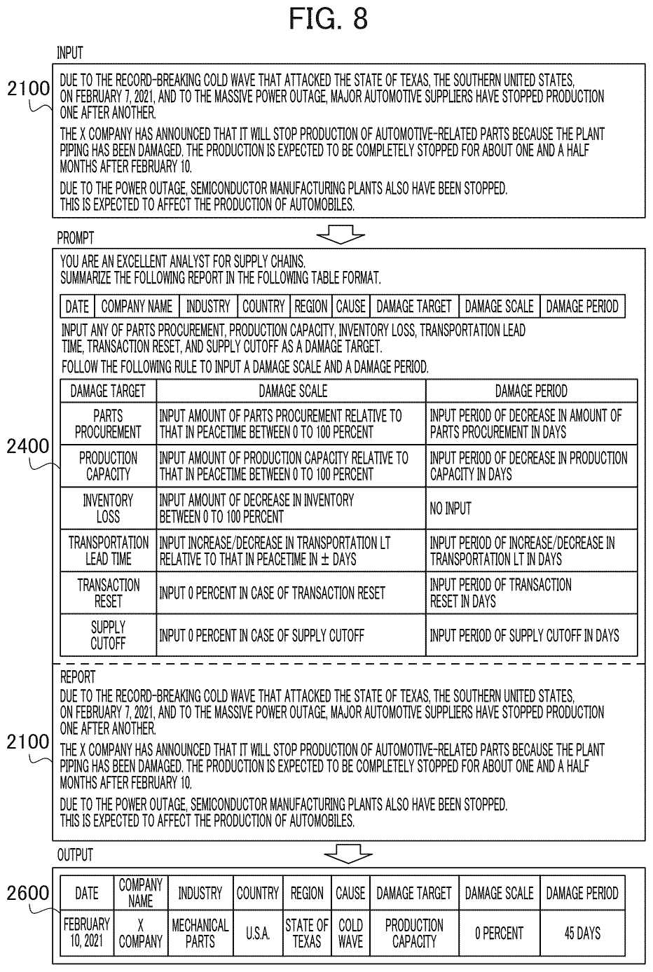

At Step S120, the damage record structuring section 1200 structures the damage record information 2100 that is unstructured data to generate the damage record structured information 2600 for each damage record information 2100 based on the damage classification master data 2400. The explanation proceeds to FIGS. 7 and 8 once in the middle of the explanation of FIG. 4.

### Damage Record Structured Information

FIG. 7 shows one example of the damage record structured information 2600. The damage record structured information 2600 stores date (column 2601), a company name (column 2602), an industry (column 2603), a country (column 2604), a region (column 2605), a cause (column 2606), a damage target (column 2607), a damage scale (column 2608), a damage period (column 2609) in association with each other. Note that the “location” means a geographical position, and is a concept including the “country” and the “region.” The damage record structured information 2600 stores the industries, the damage targets, the damage scales, and the damage periods as a database in an available form. One record of the damage record structured information 2600 corresponds to one piece of the damage record information 2100.

Note that, for example, when the risk scenario evaluation system 1000 is operated at a specific location having a small area, the damage record structured information 2600 may not have a column relating to locations. The other information generated from the damage record structured information 2600 also is treated as above. Note that, in this case, the filtering for limiting a location (described below in detail) is impossible.

The damage target of the damage record structured information 2600 is the result of replacing the corresponding portion of the damage record information 2100 with the damage target in the damage classification master data 2400 by the damage record structuring section 1200. The damage scale of the damage record structured information 2600 is the result of quantifying the corresponding portion of the damage record information 2100 by the damage record structuring section 1200 through the definition method for the damage scale in the damage classification master data 2400. The damage periods of the damage record structured information 2600 is the result of quantifying the corresponding portion of the damage record information 2100 by the damage record structuring section 1200 through the definition method for the damage periods in the damage classification master data 2400. The other columns of the damage record structured information 2600 are the results of summarizing, by the damage record structuring section 1200, the portions corresponding to the date, the company name, the industry, the country, the region, and the cause in the damage record information 2100.

### Structuring of Damage Record Information

FIG. 8 explains structuring of the damage record information. In particular, FIG. 8 is an example of structuring the damage record information 2100 by the damage record structuring section 1200 through the LMM (Large Language Models). The damage record structuring section 1200 inputs the damage record information 2100 and the damage classification master data 2400 as the conditions for structuring the damage record information 2100 into the LLM, and extracts the damage record structured information 2600. Note that the LLM is a language model constructed using a large quantity of data and a deep learning technology.

When the damage record information 2100 “the southern United States, on Feb. 7, 2021, (omission) expected to impact the production of automobiles” (in the upper row of FIG. 8) is inputted into the LLM, the damage classification master data 2400 (in the middle row of FIG. 8) is used as the input conditions (prompt) for the structuring. The output from the LLM is the damage record structured information 2600 (in the lower row of FIG. 8). The output includes the date “Feb. 10, 2021,” the company name “X company,” the industry “mechanical parts,” the country “U.S.A.,” the region “State of Texas,” the cause “cold wave,” the damage target “production capacity,” the damage scale “0 percent,” and the damage period “45 days.” This output is just a series of words for each item. However, the user is capable of understanding the summary of the damage efficiently. For example, the damage record structuring section 1200 extracts the damage target “production capacity,” the damage scale “0 percent,” and the damage period “45 days” (in the lower row in FIG. 8) from the natural language “the production of (omission) is expected to be completely stopped for about one and a half months” (in the upper row of FIG. 8).

To estimate the damage scale and the damage period generated upon realization of a risk in predicting and evaluating a damage in each risk scenario (Step S30), it is preferable to use statistical processing or machine learning as described below at Step S340. However, it is difficult to perform, e.g., statistical processing or machine learning to text data described using, e.g., a natural language, such as the damage record information 2100, and to estimate the damage scale and the damage period. Then, it is meaningful that the damage record structuring section 1200 structures the damage record information 2100 that is the text data described using, e.g., a natural language and changes the damage record information 2100 into a table format to which statistical processing or machine learning is processable. The explanation returns to FIG. 4.

At Step S130, the damage record structuring section 1200 filters the damage record structured information 2600 by a company name, and deletes duplicate data. For example, in the damage record structured information 2600 of FIG. 7, when multiple records having the same company name (column 2602) are present, the damage record structuring section 1200 keeps one record and deletes the other ones. The filtering means deletion of duplicate information or unnecessary information.

Thus, even when the same damage record information 2100 is acquired from different data sources, the specific damage record information 2100 is prevented from having an apparent significant influence in estimation of a damage scale and the damage period, and a decrease in the estimation accuracy is preventable. Note that the method of determining the data duplication is not limited to the above one, and a method including the other columns of the damage record structured information 2600 or a method of, e.g., clustering may be used. After the end of the process at Step S130, a sequence of processes performed by the damage record structuring section 1200 at Step S10 ends.

### Details at Step S20

FIG. 9 is a flowchart of a detailed procedure at Step S20 of FIG. 3.

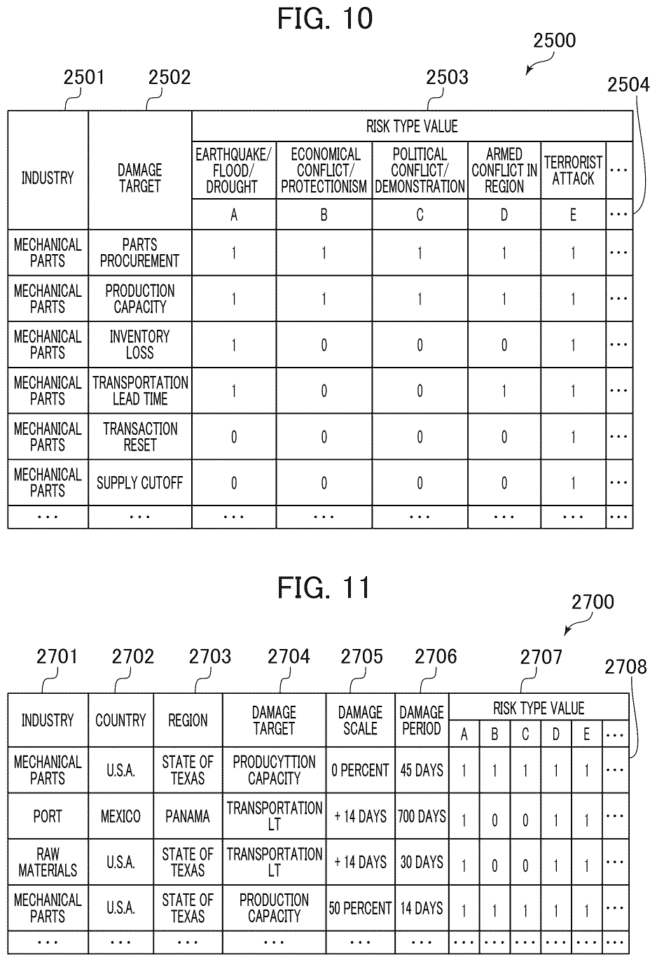

At Step S210, the damage record abstracting section 1300 acquires the damage record structured information 2600 and the risk response master data 2500 stored in the data storage section 2000. The explanation proceeds to FIG. 10 once in the middle of the explanation of FIG. 9.

### Risk Response Master Data

FIG. 10 shows one example of the risk response master data 2500. The information collection management section 1100 acquires the risk response master data 2500 by a manual input or a data upload via the input and output interface section 1600.

The risk response master data 2500 stores the industry (column 2501), the damage target (column 2502) and the risk type value (2503) in association with each other. The risk type value herein (column 2503) is binary (“1” or “0”) for each risk type. The risk type includes, for example, “A: earthquake, flood, drought,” “B: economical conflict, protectionism,” “C: political conflict, demonstration,” “D: armed conflict in region,” and “E: terrorist attack.” The “1” herein shows that the occurrence of the risk belonging to the corresponding risk type impacts the damage target (column 2502). The “0” shows that the occurrence of the risk belonging to the corresponding risk type does not impact the damage target (column 2502).

For example, with respect to the “parts procurement,” the “production capacity,” the “inventory loss,” the “transportation lead time,” the “transaction reset,” and the “supply cutoff,” which are the damage targets of the “mechanical parts” in the industry, the risk type values of the risk type “A: earthquake, flood, drought” are “1, 1, 1, 1, 0, 0.” This indicates that the earthquake, flood, drought impacts the parts procurement, the production capacity, the inventory loss, and the transportation lead time, and does not impact the transaction reset or the supply cutoff. The risk type value may be a real number that is a continuous value equal to or more than “0” and equal to or less than “1” in addition to the above binary.

As described above, the risk types of FIG. 10 are different in concept from the causes of FIG. 7. For example, the “cold wave” as the cause is specifically imaginable by the user as a phrase described in news. In contrast, the user who imagines the cold wave is not necessarily capable of imagining also the earthquake, flood, or drought. However, in the meaning that the damages caused by the “earthquake, flood, drought” as one risk type are similar to the damages caused by the “cold wave,” the “earthquake, flood, drought” may be a superordinate concept relative to the “cold wave.” The risk response master data 2500 has a role to supplement the so-called blank in imagination of the user who is capable of imagining a cold wave, but incapable of imagining the earthquake, the flood, or the drought additionally.

Note that the damage record abstracting section 1300 regards a cause as a risk, and is capable of identifying a risk type to which the risk belongs. For example, the damage record abstracting section 1300 regards the cause “flood” as the risk “flood,” and is capable of identifying the risk type “A: earthquake, flood, drought” to which the risk “flood” belongs. Similarly, the damage record abstracting section 1300 regards the cause “cold wave” as the risk “cold wave,” and is capable of identifying the risk type “A: earthquake, flood, drought” to which the risk “cold wave” belongs. That is, the risk type “A” indicates common natural disasters. The explanation returns to FIG. 9.

At Step S220, the damage record abstracting section 1300 supplements each record of the damage record structured information 2600 for each record of the damage record structured information 2600 with information about a risk that is likely to occur by use of the risk response master data 2500 to generate the damage record abstracted information 2700. The explanation proceeds to FIG. 11 once in the middle of the explanation of FIG. 9.

### Damage Record Abstracted Information

FIG. 11 shows one example of the damage record abstracted information 2700. The damage record abstracted information 2700 stores the industry (column 2701), the country (column 2702), the region (column 2703), the damage target (column 2704), the damage scale (column 2705), the damage period (column 2706), and the risk type value (2707) in association with each other. The damage record abstracted information 2700 supplements the cause of the damage that has actually occurred in the past with a risk that has not actually occurred but is likely to occur in the future. When FIG. 11 is compared to FIG. 7, the causes in FIG. 7 are replaced with the risk type values in FIG. 11.

For example, a record 2610 of FIG. 7 stores the industry “mechanical parts” and the damage target “production capacity.” A record 2504 of FIG. 10 stores the industry “mechanical parts,” the damage target “production capacity,” and the risk type values “1, 1, 1, 1, 1, . . . ” From these results, a record 2708 of FIG. 11 stores the industry “mechanical parts,” the damage target “production capacity,” and the risk type values “1, 1, 1, 1, 1, . . . ”

Thus, for example, from the cause of the damage, which is the cold wave, the risk type “earthquake, flood, drought” (natural disasters) that may be a similar cause to the above one is extractable as the superordinate concept. In addition, for example, it is assumed that no armed conflict has occurred in the State of Texas in the United States. The cause of the damage due to the armed conflict does not exist in reality. However, also in this case, when the contents of the risk response master data 2500 are devised, it is possible to treat the damage record information generated from a cold wave as the damage record information that may be generated from an armed conflict in an extreme case.

This reason is as follows. Now, the damage target is assumed as the production capacity. Three cases may be assumed, the cases including: the case in which production is stopped because production equipment is damaged by a cold wave; the case in which production is stopped because production equipment is damaged by an earthquake; and the case in which production is stopped because production equipment is damaged by an armed conflict. This is because these three cases are considered as the same event in which the production equipment is damaged to stop production.

In predicting and evaluating the damage for each risk scenario with respect to the damage record structured information 2600 at Step S30, when there is no record of the damage record structured information 2600 with respect to the assumed risk, it is difficult to predict the damage scale and the damage period of the risk having no corresponding record. Thus, by generating the damage record abstracted information 2700, a different record is capable of being treated as a damage that may occur due to the assumed risk also when there is no record of the damage record structured information 2600 with respect to the assumed risk. As a result, at Step S340 after-mentioned, through the process such as statistical processing or machine learning, the damage for each risk scenario is capable of being predicted and evaluated. The explanation returns to FIG. 9. After the end of the process at Step S220, a sequence of processes operated by the damage record abstracting section 1300 is ended.

### Relationship Between Cause and Risk

In accordance with the above description, a cause and a risk are viewed differently, but the same as each other essentially. Additionally, the superordinate concept of the risk is a risk type. However, more commonly, even if the risk type is not the superordinate concept of the cause, the risk type is sufficiently useful when relating to the cause. The user wants to know a different unnoticeable cause by using the concept referred as the risk type. Then, the risk type is the superordinate concept of the cause in many cases.

### Details at Step S30

FIG. 12 is a flowchart of a detailed procedure at Step S30 of FIG. 3.

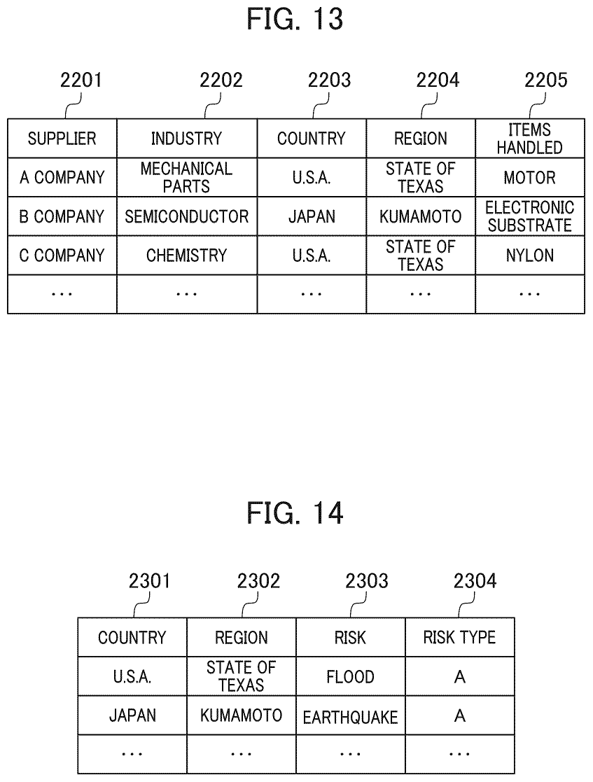

At Step S310, the risk scenario evaluation section 1400 acquires the supply chain information 2200, the risk scenario information 2300 and the damage record abstracted information 2700 stored in the data storage section 2000. The explanation proceeds to FIGS. 13 and 14 once in the middle of the explanation of FIG. 12.

### Supply Chain Information

FIG. 13 shows one example of the supply chain information 2200. The supply chain information 2200 stores the suppliers (column 2201), the industries (column 2202), the countries (column 2203), the regions (column 2204), and the handled items (column 2205) in association with each other. The information collection management section 1100 automatically acquires information required to generate the supply chain information 2200 from an EDI or public company information via the input and output interface section 1600. The information collection management section 1100 stores the completed supply chain information 2200 in the data storage section 2000. At this time, the information collection management section 1100 matches the format of the acquired data with the format of the information in each column, as required.

In general, the suppliers are linked hierarchically, such as a first subcontractor, a second subcontractor, a third subcontractor, and so on. The supplier column 2201 may store also a hierarchical distance from a user's company, such as a “hierarchical rank.” Further, the user performs the present embodiment as multiple buyers. Then, the supply chain information 2200 may have a buyer column describing names of buyers.

### Risk Scenario Information

FIG. 14 shows one example of the risk scenario information 2300. The risk scenario information 2300 stores the country (column 2301), the region (column 2302), the risk (column 2303) and the risk type (column 2304) in association with each other. As is obvious in FIG. 14, one record of the risk scenario information 2300 corresponds to one risk scenario. The risk scenario relates a future risk assumed by the user to the risk type and the location that are the superordinate concepts of the assumed risk.

The information collection management section 1100 may purchase, e.g., disaster prevention/crisis management information from, e.g., insurance companies or evaluation organizations via the input and output interface section 1600 to generate the risk scenario information 2300. The explanation returns to FIG. 12.

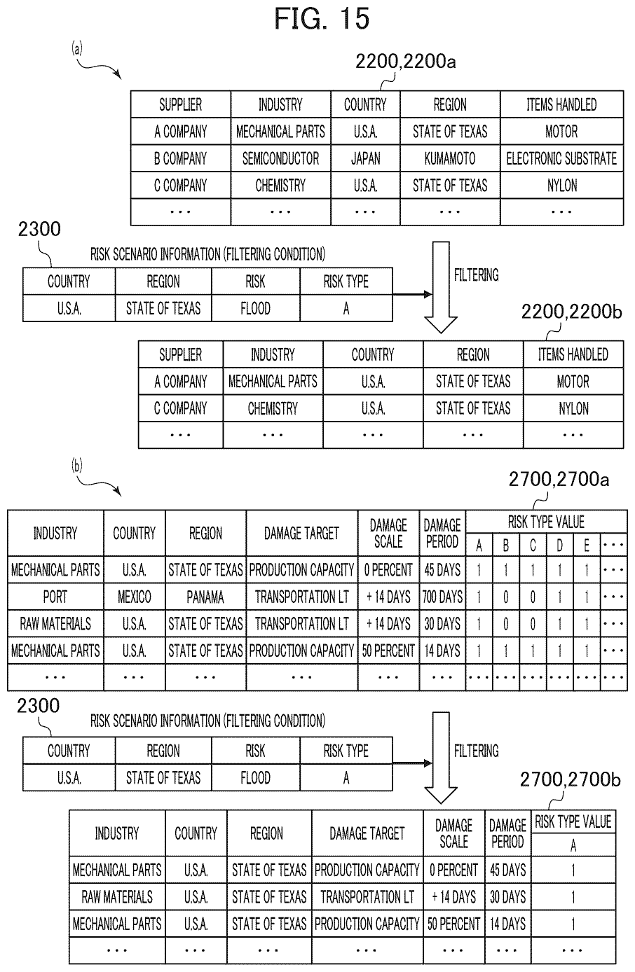

At Step S320, the risk scenario evaluation section 1400 filters the supply chain information 2200 by the risk type, the country, and the region for each record of the risk scenario information 2300, and similarly filters the damage record abstracted information 2700. The explanation proceeds to FIG. 15 once in the middle of the explanation of FIG. 12.

### Filtering at Step S320

FIG. 15 explains filtering at Step S320 of FIG. 12. The risk scenario evaluation section 1400 filters the supply chain information 2200 and the damage record abstracted information 2700 respectively for each one record of the risk scenario information 2300. The filtering condition in this case (value of each item remained without being deleted) is the record of the risk scenario information 2300.

FIG. 15(a) is to be noted first. A certain record forming the risk scenario information 2300 stores the country “U.S.A.,” the region “State of Texas,” and the risk “flood,” and the risk type “A.” The risk scenario evaluation section 1400 filters the supply chain information 2200 by using the corresponding record as the filtering condition. In comparison with supply chain information 2200a before filtered, the record about the country “Japan” is deleted in supply chain information 2200b after filtered. This is because the filtering condition contains the country “U.S.A.,” but does not contain the country “Japan.”

Next, FIG. 15(b) is to be noted. As well as in FIG. 15(a), a certain record forming the risk scenario information 2300 stores the country “U.S.A.,” the region “State of Texas,” and the risk “flood,” and the risk type “A.” The risk scenario evaluation section 1400 filters the damage record abstracted information 2700 by using the corresponding record as the filtering condition. In comparison with supply chain information 2700a before filtered, the record about the country “Mexico” is deleted in supply chain information 2700b after filtered. Further, the small columns other than “A” in the column of the risk type value are deleted. This is because the filtering condition contains the country “U.S.A.,” and the risk type “A”, but does not contain the country “Mexico”, and the risk type “B, C, D, E , , , ”. The explanation returns to FIG. 12.

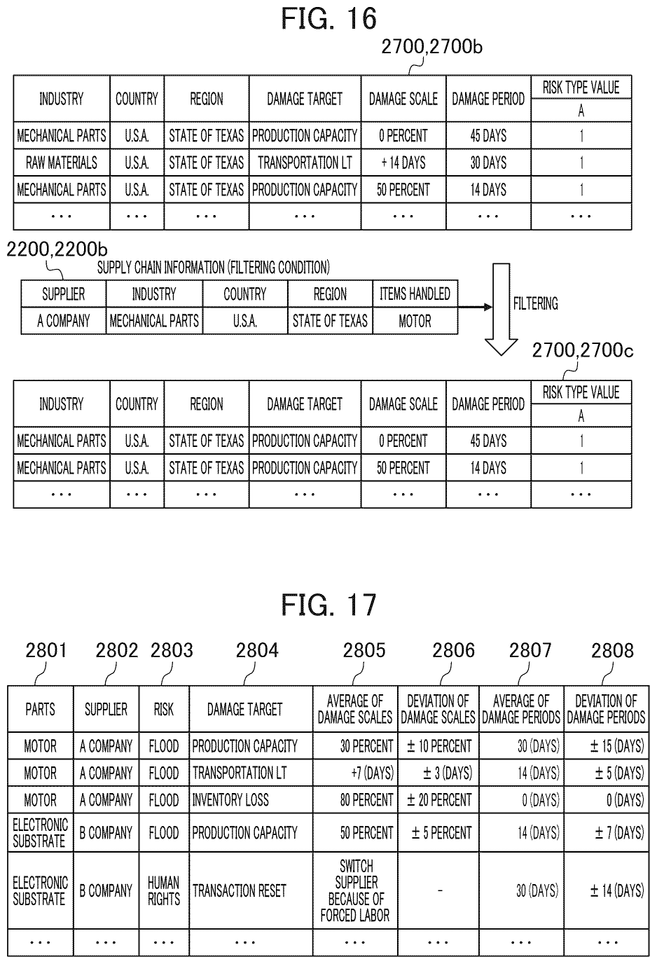

At Step S330, the risk scenario evaluation section 1400 filters the damage record abstracted information 2700 by the industry, the country, and the region for each supplier of the supply chain information 2200. The explanation proceeds to FIG. 16 once in the middle of the explanation of FIG. 12.

### Filtering at Step S330

FIG. 16 explains filtering at Step S330 of FIG. 12. The risk scenario evaluation section 1400 filters the damage record abstracted information 2700b filtered at Step S320 for each one record of the supply chain information 2200b filtered at Step S320.

For example, the risk scenario evaluation section 1400 filters the damage record abstracted information 2700b of FIG. 15(b) by using one record of the supply chain information 2200b of FIG. 15(a) as the filtering condition. One record forming the supply chain information 2200b stores the supplier “A company,” the industry “mechanical parts,” the country “U.S.A.,” the region “State of Texas,” and the handled item “motor.” In comparison with supply chain information 2700b before filtered, the record about the industry “mechanical parts” is deleted in supply chain information 2700c after filtered. This is because the filtering condition contains the industry “mechanical parts,” and does not contain the industry “raw material.”

The damage record abstracted information 2700c after filtered has no column for suppliers. However, the risk scenario evaluation section 1400 relates the supplier “A company” to the damage record abstracted information 2700c. This is because the user knows, from the damage record abstracted information 2700c of FIG. 16, the damage that may be suffered by the A company as a supplier for the user's company. The explanation returns to FIG. 12.

At Step S340, the risk scenario evaluation section 1400 calculates the damage scale and the damage period due to a risk for each damage target, and generates the risk scenario evaluation information 2800 based on the supply chain information 2200, the risk scenario information 2300, and the calculation results. The explanation proceeds to FIG. 17 once in the middle of the explanation of FIG. 12.

### Risk Scenario Evaluation Information

FIG. 17 shows one example of the risk scenario evaluation information 2800. The risk scenario evaluation information 2800 stores parts (column 2801), suppliers (2802), risks (column 2803), damage targets (column 2804), averages for damage scales (column 2805), deviations for damage scales (column 2806), averages for damage periods (column 2807), and deviations for damage periods (column 2808) in association with each other. The explanation returns to FIG. 12.

The risk scenario evaluation section 1400 performs statistical processing for each damage target by use of the damage record abstracted information 2700c filtered at Step S330, and calculates an average of the damage scales, a deviation of the damage scales, an average of the damage periods, and a deviation for the damage periods. For example, an index indicating a deviation uses, for example, a variance. Note that the calculation method is not limited to the present method. The calculation may use, for example, a machine learning method.

The risk scenario evaluation section 1400 repeats the processes at Step S330 and Step S340 (outer loop) for each supplier, and repeats the statistical processing at Step S340 for each damage target (inner loop). As a result, for example, two records of the damage record abstracted information 2700c (the records about the A company) on the bottom row of FIG. 16 are statistically aggregated as one record in the risk scenario evaluation information 2800 of FIG. 17. After the end of the process at Step S340, a sequence of the processes performed by the risk scenario evaluation section 1400 at Step S30 is ended.

### Screen Example

FIG. 18 is one example of a risk scenario evaluation result screen 3000. At Step S40, the risk evaluation result display section 1500 displays the risk scenario evaluation result screen 3000 on the display device 15 or the terminal device 40. The contents of the risk scenario evaluation result screen 3000 are generally the same as the risk scenario evaluation information 2800. From the risk scenario evaluation information 2800 of FIG. 17, the followings become clear.

The parts “motors” are supplied from the supplier “A company.”

When the risk “flood” actualizes, the “production capacity,” the “transportation lead time (LT),” and the “inventory loss” are assumable as the damage targets.

When the damage target is the “production capacity,” the average damage scale is “30 percent,” the damage scale deviation is “plus or minus 10 percent,” the average damage period is “30 (days),” and the damage period deviation is “plus or minus 15 (days).”

### Advantageous Effects of Embodiments

The user (buyer) of the risk scenario evaluation system 1000 is capable of assuming the risks that are difficult to quantitatively evaluate using conventional manual operations and that are faced by the suppliers, and estimating the damage scales and the damage periods that impact the suppliers due to troubles and disasters in peacetime. In addition, in risk management operations, which have been manually operated by a buyer, omissions of risks are avoidable, the omissions being occurred by buyer-dependent recognitions, and risk management is performable to risks that are difficult for the buyer to assume. Thus, the buyer is capable of developing measure plans to avoid the risk in advance to meet the damage target, the damage scale, and the damage period that are assumed from the risk to the supplier.

It should be noted that the present invention is not limited to the embodiments described above, and includes various modifications. For example, the above-described embodiments have been described in detail in order to facilitate the understanding of the present invention, and the present invention is not necessarily limited to those including all of the described configurations. In addition, part of the configuration of the above-described embodiments can be subjected to addition, deletion, or replacement with respect to other configurations.

In addition, part or all of the above configurations, functions, processing sections, processing means, and so on may be achieved using hardware, e.g., designed using an integrated circuit. In addition, the above configurations, functions, and so on may be achieved using software by translation and execution of programs by a processor. The information about the programs, tables, files, and so on achieving each function can be stored on recording devices such as memory devices, hard disks, SSDs, and so on or recording media such as IC cards, SD cards, DVDs, and so on. In addition, control wires and information lines considered to be required for explanation are shown. All the control wires and the information lines on a product are not necessarily shown. In actual, generally all the configurations may be considered to be connected to each other.

Although embodiments of the present invention have been described and illustrated in detail, the disclosed embodiments are made for purposes of illustration and example only and not limitation. The scope of the present invention should be interpreted by terms of the appended claims.

What is claimed is:

1. A risk scenario evaluation system comprising:
a damage record structuring section that generates
damage record structured information storing a damage target, a damage scale, and a damage period as a database in an available format
from damage record information storing a cause of the damage, the damage scale, and the damage period in a supply chain as a text of a natural language
on a basis of damage classification master data storing the damage target that is a type of the damage to be noted, a method of defining the damage scale, and a method of defining the damage period; and
a damage record abstracting section that generates damage record abstracted information storing a risk type value in association with the damage target, the damage scale, and the damage period
from the damage record structured information
on a basis of risk response master data storing the risk type value that is an index of a magnitude of an impact on the damage target due to a risk type related to the cause of the damage.

2. The risk scenario evaluation system according to claim 1 comprising:
a risk scenario evaluation section that generates risk scenario evaluation information storing statistics for the damage scales and the statistics for the damage periods in association with the supplier and the damage target
from the damage record abstracted information
on a basis of risk scenario information storing the risk type and supply chain information storing the supplier, the risk type and the supplier being stored as conditions for limiting a record of the damage record abstracted information.

3. The risk scenario evaluation system according to claim 2 comprising:
a risk scenario evaluation result display section that displays the risk scenario evaluation information.

4. The risk scenario evaluation system according to claim 1 wherein
the damage target includes at least any one of parts procurement, a production capacity, an inventory loss, a transportation lead time, and a transaction reset.

5. The risk scenario evaluation system according to claim 1 wherein
the damage record structuring section uses LLM (Large Language Models) in generating the damage record structured information.

6. The risk scenario evaluation system according to claim 2 wherein
the risk scenario evaluation information includes
an average and a deviation for the damage scales as statistics for the damage scales, and includes an average and a deviation for the damage periods as statistics for the damage periods.

7. A risk scenario evaluation method wherein
a damage record structuring section of a risk scenario evaluation system generates
damage record structured information storing a damage target, a damage scale, and a damage period as a database in an available form
from damage record information storing a cause of a damage, the damage scale, and the damage period in a supply chain as a text of a natural language
on a basis of damage classification master data storing the damage target that is a type of the damage to be noted, a definition method for the damage scale, and a definition method for the damage period, and
a damage record abstracting section of the risk scenario evaluation system generates damage record abstracted information storing a risk type value
from the damage record structured information in association with the damage target, the damage scale, and the damage period
on a basis of risk response master data storing the risk type value that is an index of a magnitude of an impact on the damage target by a risk type related to the cause of the damage.
